(19) United States
(12) Patent Application Publication
(10) Pub. No.: US 2011/0302046 A1
(43) Pub. Date: Dec. 8, 2011

(54) PROFESSIONAL SERVICES WEBSITE

(76) Inventor: AFSHIN ARIAN, Las Vegas, NV (US)

(21) Appl. No.: 13/154,322

(22) Filed: Jun. 6, 2011

Related U.S. Application Data
(60) Provisional application No. 61/344,173, filed on Jun. 4, 2010.

(51) Int. Cl. G06Q 30/00

(52) U.S. Cl. 705/26.3

(57) ABSTRACT

The professional services website includes a mass storage unit connected to a web server. The web server serves a plurality of web pages, which allow for user submission of a description of professional services, a transaction date, and an offer to pay for the services. An application server communicates with the web server and is also connected to the mass storage unit. The application server maintains a database of professional service providers. The database resides on the mass storage unit. Using data from the application server and database, the website mediates communication between the user and professional service providers who accept the user's offer. The only communication permitted by the professional website between the professional service providers and the user is an acceptance of the user's offer with no preconditions. There is no bid/ask, i.e., no counter offer is allowed.

### CROSS-REFERENCE TO RELATED APPLICATION

This application claims the benefit of U.S. Provisional Patent Application Ser. No. 61/344,173, filed Jun. 4, 2010.

### BACKGROUND OF THE INVENTION

1. Field of the Invention

The present invention relates to auction bidding websites, and more particularly to a professional services website in which clients anonymously bid for professional services.

2. Description of the Related Art

An online tool that allows for auction in the vertical market of all professional services would be desirable. Such an application would reverse the role of the clients and providers while driving expenses downward, resulting in an expanding providers' customer base. In this auction model, providers would compete to obtain clients' business.

Thus, a professional services website solving the aforementioned problems is desired.

### SUMMARY OF THE INVENTION

The professional services website includes a mass storage unit connected to a web server. The web server serves a plurality of web pages, which allow for user submission of an offer to pay for professional services. An application server communicates with the web server and is also connected to the mass storage unit. The application server maintains a database of professional service providers. The database resides on the mass storage unit. Using data from the application server and database, the website mediates communication between the user and professional service providers who accept the user's offer. The only communication permitted by the professional website between the professional service providers and the user is an acceptance of the user's offer with no preconditions. There is no bid/ask, i.e., no counter offer is allowed.

These and other features of the present invention will become readily apparent upon further review of the following specification and drawings.

### BRIEF DESCRIPTION OF THE DRAWINGS

FIG. 1 is a diagrammatic view of a system providing the professional services website according to the present invention.

FIG. 2 is a screenshot showing the website homepage, according to the present invention.

FIG. 3 is a screenshot showing the website login page, according to the present invention.

FIG. 4 is a screenshot showing the website place bid page, according to the present invention.

FIG. 5 is a screenshot showing the website my bids page, according to the present invention.

FIG. 6 is a screenshot showing the website my bids page after adding a new bid, according to the present invention.

FIG. 7 is a screenshot showing the website my bids page detailing a bid, according to the present invention.

FIG. 8 is a screenshot showing the website my bids page are you sure message before cancelling bid, according to the present invention.

FIG. 9 is a screenshot showing the website my bids page showing the bid cancellation confirmation, according to the present invention.

FIG. 10 is a screenshot showing the website login page and populated provider login fields, according to the present invention.

FIG. 11 is a screenshot showing bids available for accept/reject, according to the present invention.

FIG. 12 is a screenshot showing Open bids page of the professional services website, according to the present invention.

FIG. 13 is a screenshot showing all accepted bids, according to the present invention.

FIGS. 14A and 14B show a screenshot illustrating an on-line user registration form, according to the present invention.

FIGS. 15A, 15B and 15C show a screenshot illustrating the Provider's Registration page, according to the present invention.

Similar reference characters denote corresponding features consistently throughout the attached drawings.

### DETAILED DESCRIPTION OF THE PREFERRED EMBODIMENT

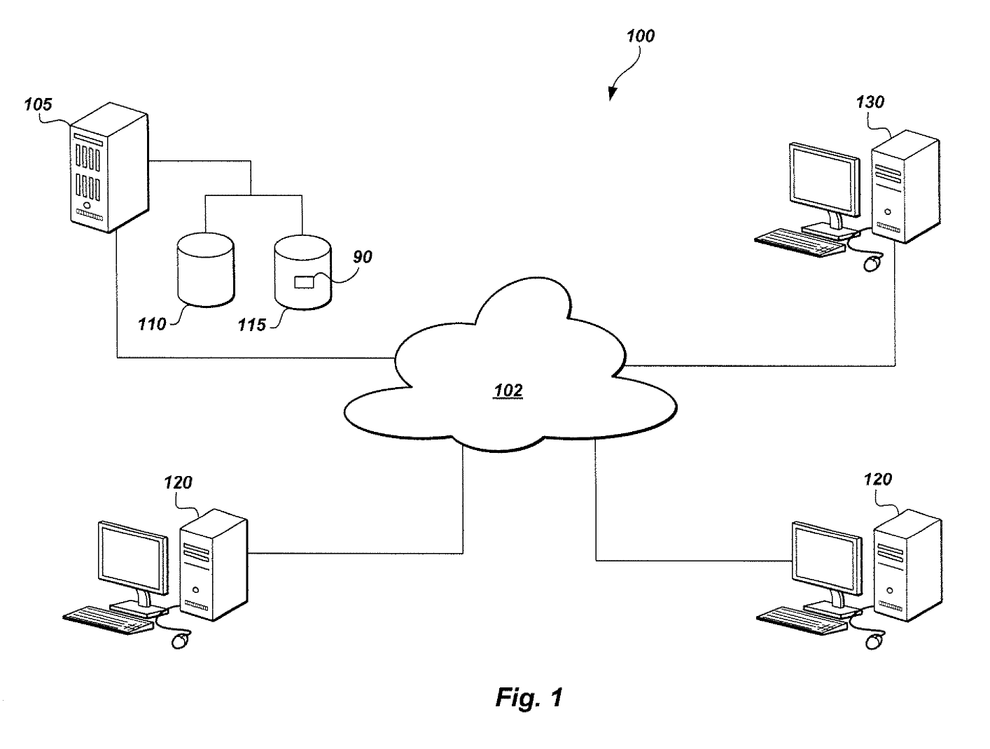

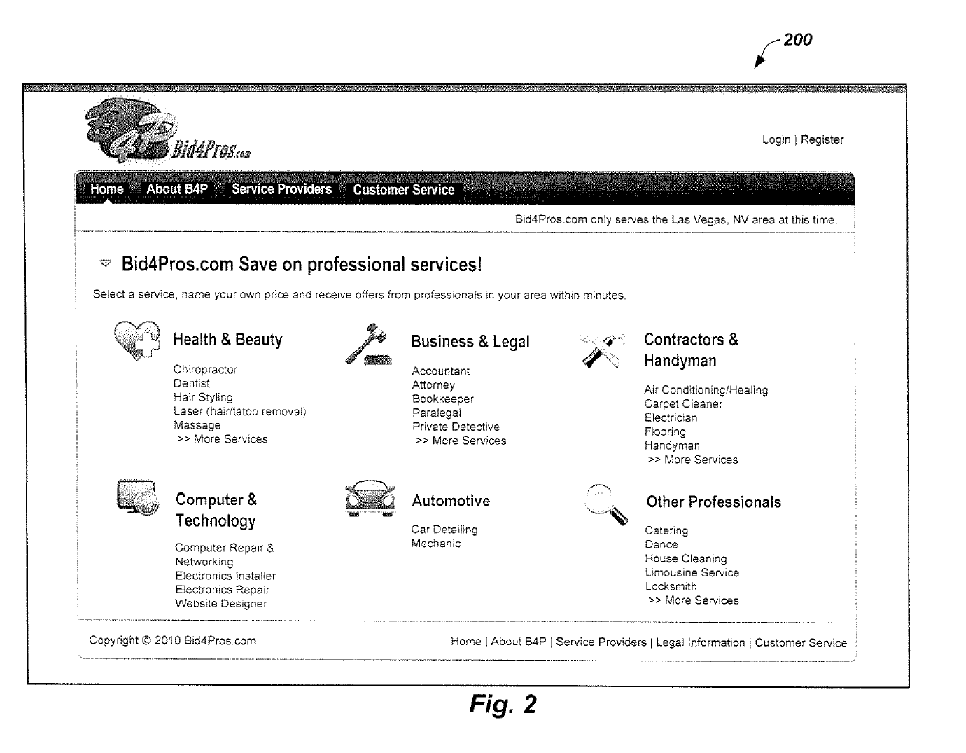

As shown in FIGS. 1 and 2, the professional services website 200 includes a mass storage unit 110 connected to a web application server 105 in a wide area networking environment 100. Shoppers using devices 120 and service providers using device(s) 130 connect to website 200 via Internet 102. The web application server 105 serves a plurality of web pages, which allow for user submission via user web-enabled device 120 of an offer to pay for professional services. Application portion of server 105 communicates with the web portion of server 105 and may be connected to the mass storage unit 110 and additional mass storage unit 115.

A database 90 of professional service providers may reside on mass storage units 110 and 115 jointly or singly. The application portion of server 105 maintains the professional service providers database 90. Using data from server 105 and database 90, the website 100 mediates communication between an anonymous user and professional service providers who can accept the user's offer. The only communication permitted by the professional website 100 between the professional service providers and the user is an acceptance of the user's offer with no preconditions. There is no bid/ask, i.e., no counter offer is allowed.

The professional services website 200 provides an online tool, e.g., Bid4pros.com, which allows for auction in the vertical market of potentially all professional services. It is an application in which the roles of the clients and providers are reversed, in that the clients do the bidding and the providers may choose to accept with no preconditions or reject the bid. Thus, the website provides an incentive to drive expenses downward while expanding the professional service providers' customer base. In this auction model, providers compete to obtain clients' business. The website generates a win-win market situation for both participating parties. The client is able to seek a lower cost for the same or better service quality while providers are able to transparently compete to get clients' business and this way expand their chances of customer-base enlargement therefore income increase.

The professional services website 200 provides web pages in which the client bids for services by listing a specific price for a specified time and date, including a detailed description of the service and its hourly or job rate. The service provider receives bids and approves/rejects bids for the date. In the bid process, as shown in FIG. 2, the website 200 provides a plurality of services from which the client can select and present a bid to be considered by the professional service provider.

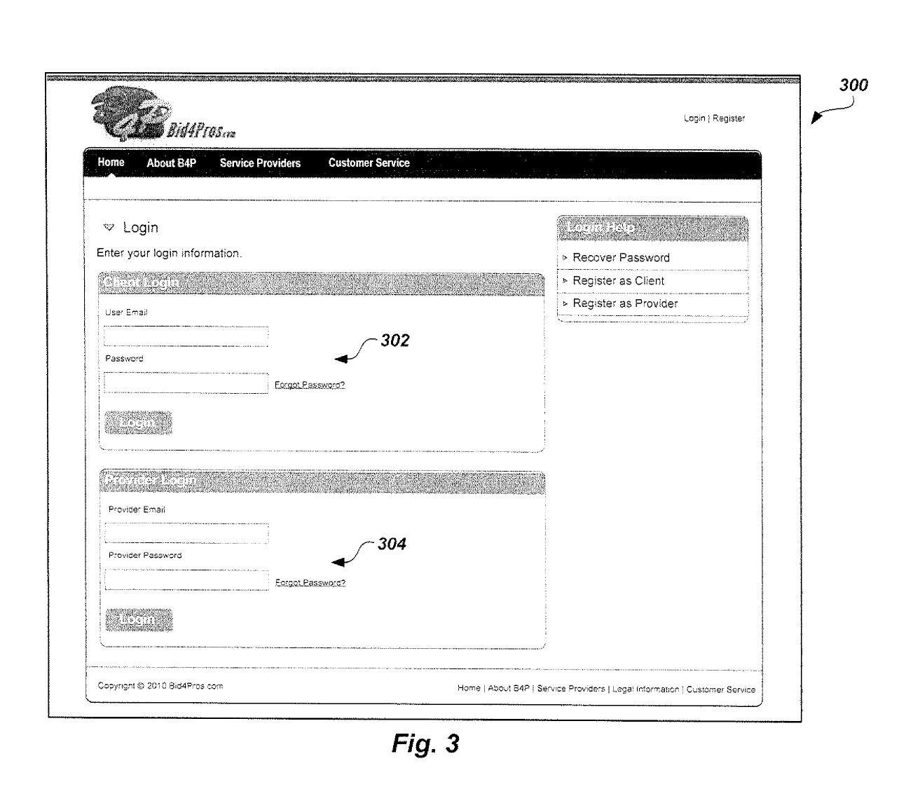

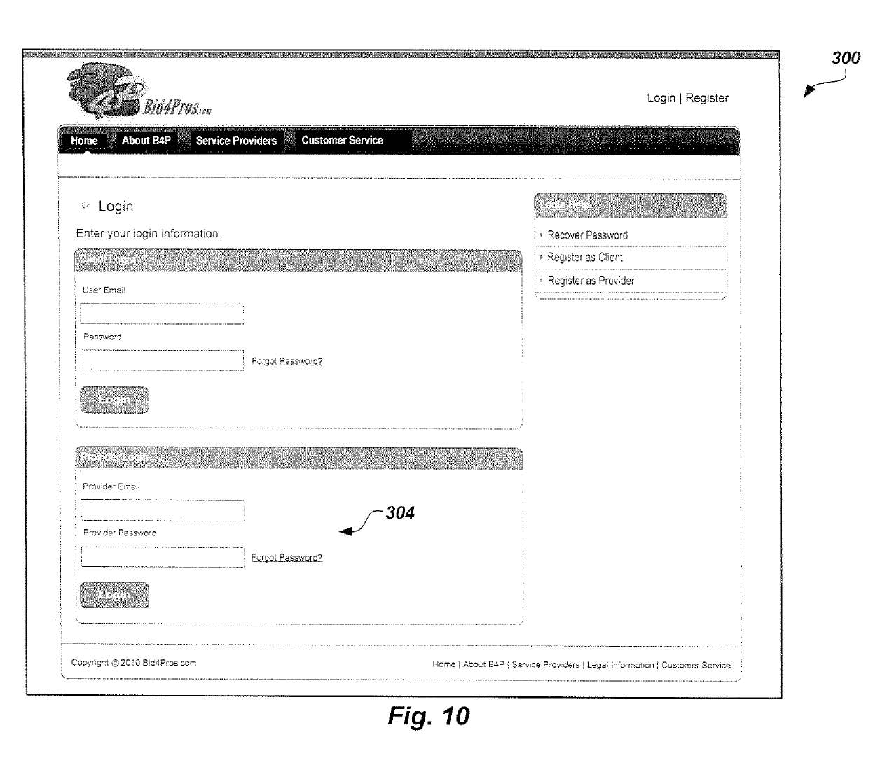

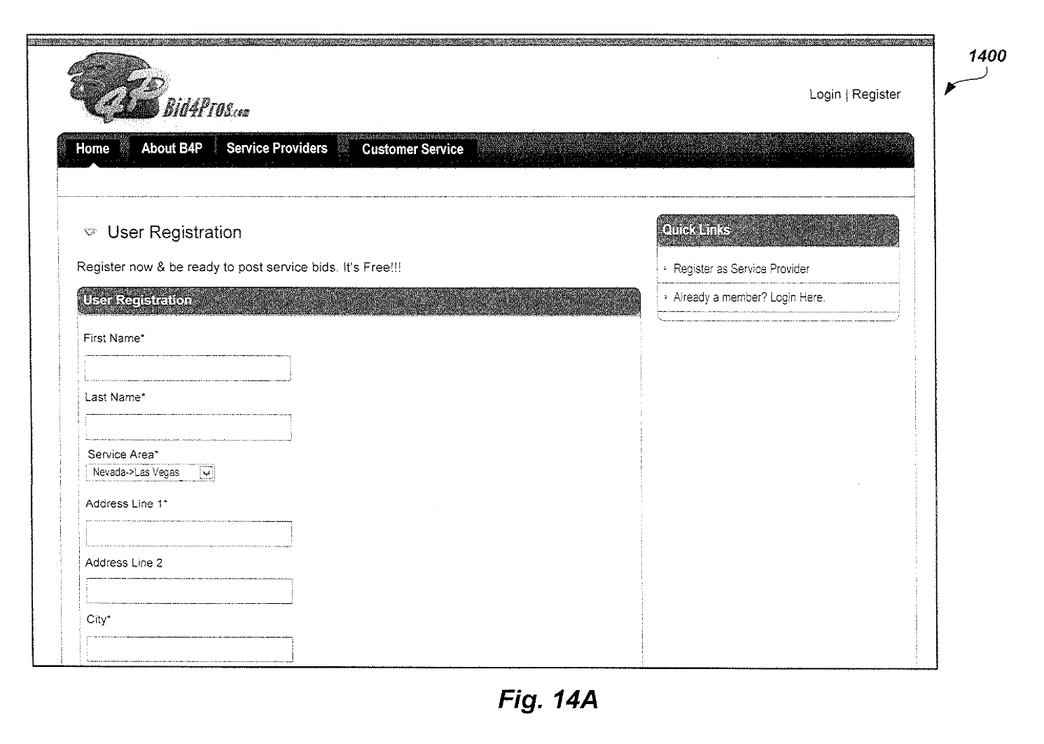

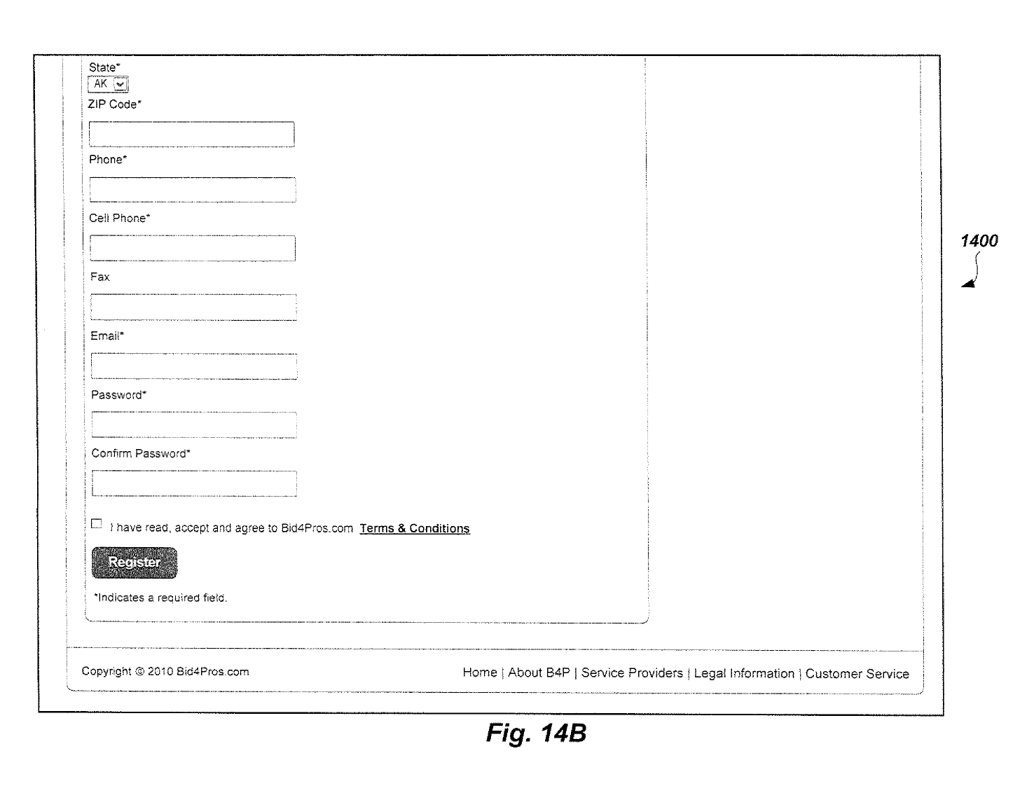

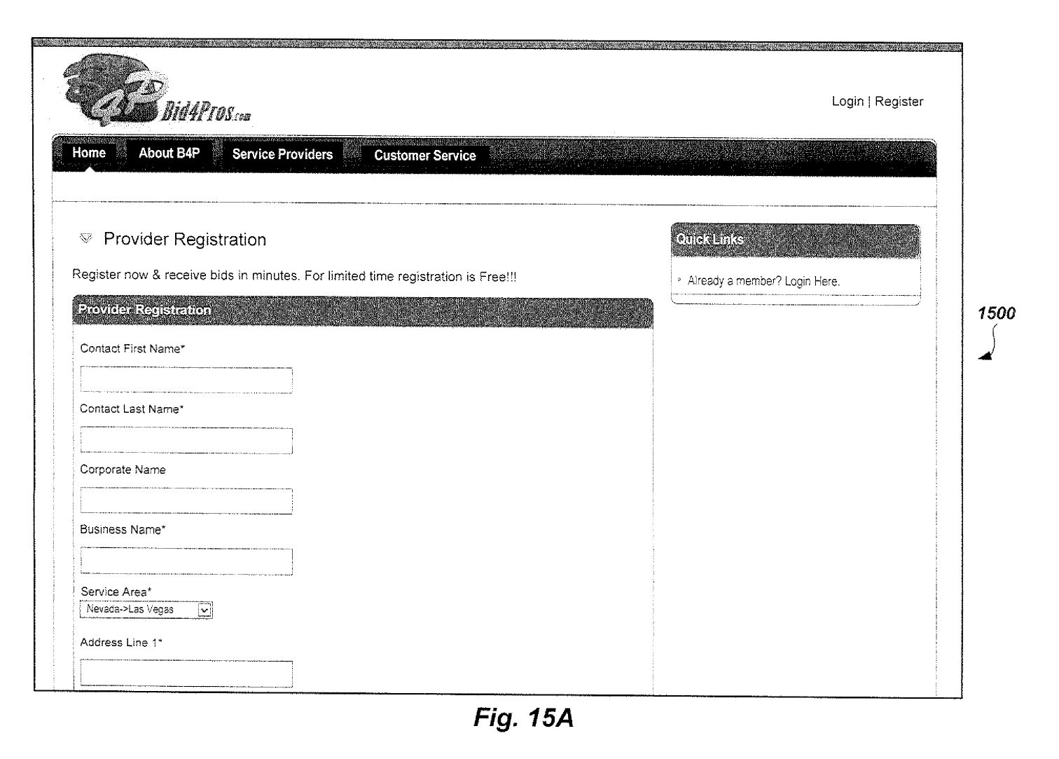

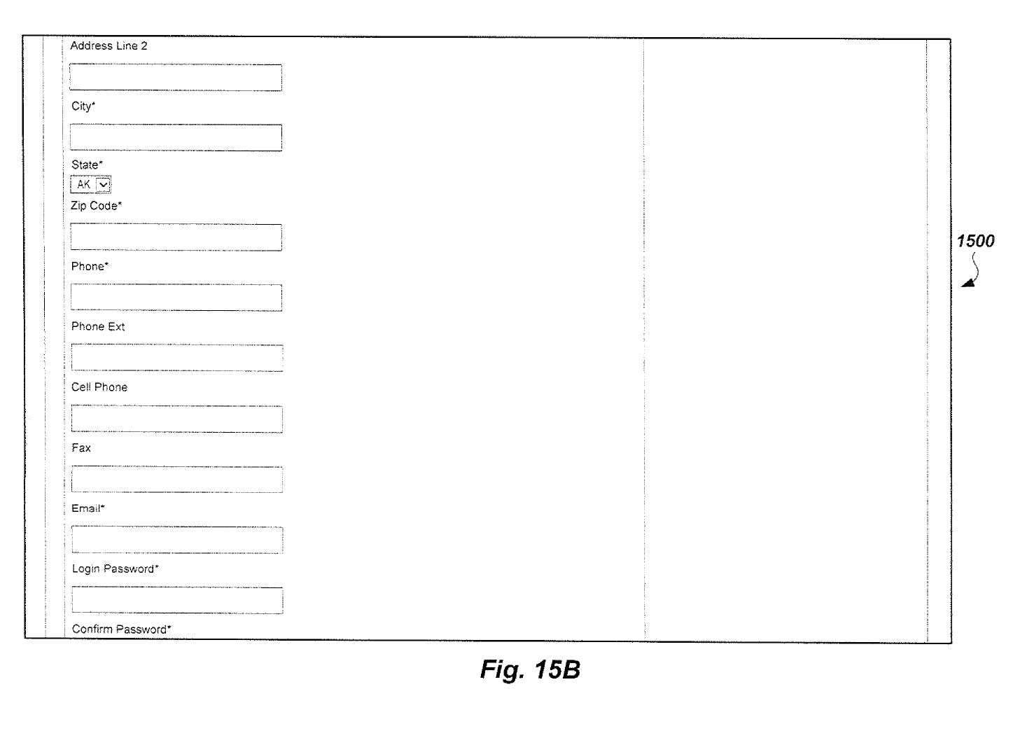

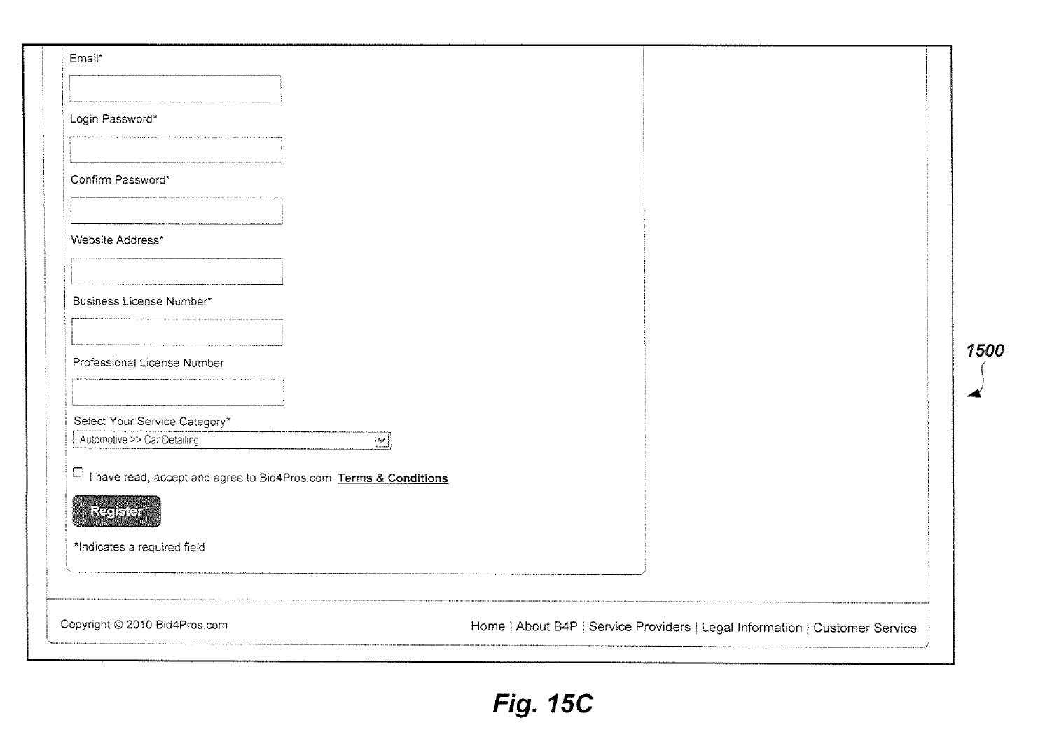

As shown in FIGS. 14a-14b, the website 200 provides an on-line registration form 1400 that a new client user fills out to gain free access to the knowledge base about all the available professional services that can be bid on. Once registered, the client can utilize the login page 300 (shown in FIG. 3) to access the system via username and password fields 302. New providers may register by accessing the Provider's Registration page 1500, as shown in FIGS. 15a-15c. Registered service providers can login by filling in provider email and password fields 304 of Login page 300, as shown in FIG. 10.

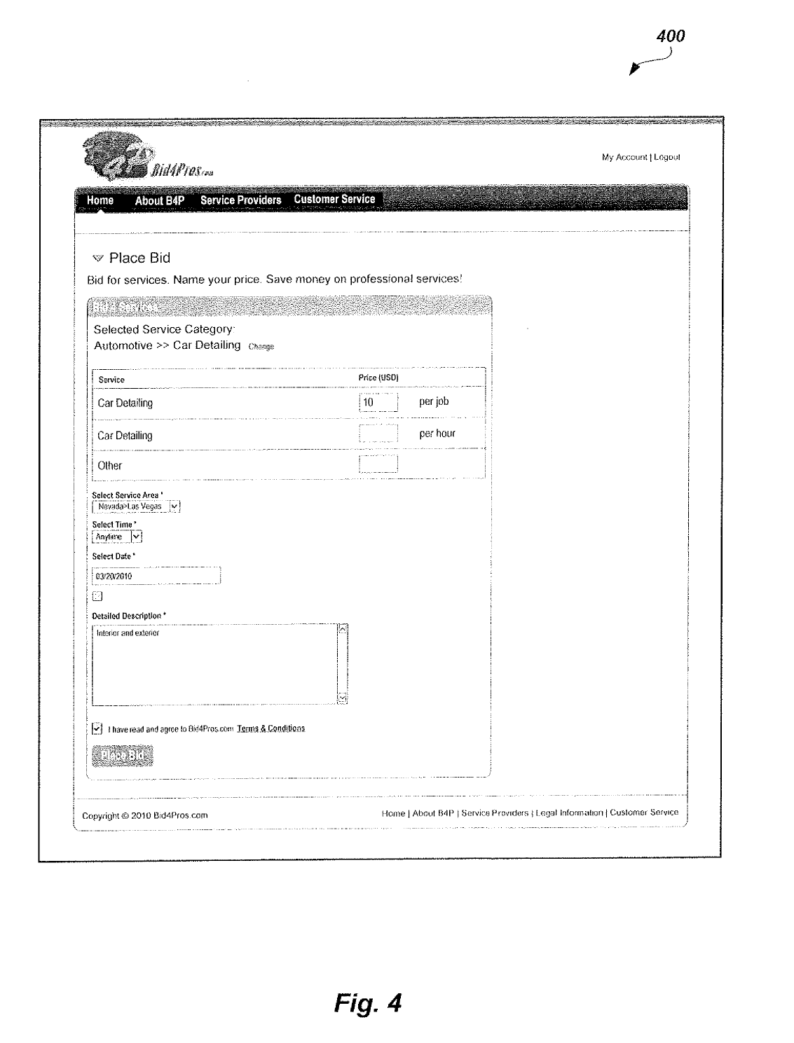

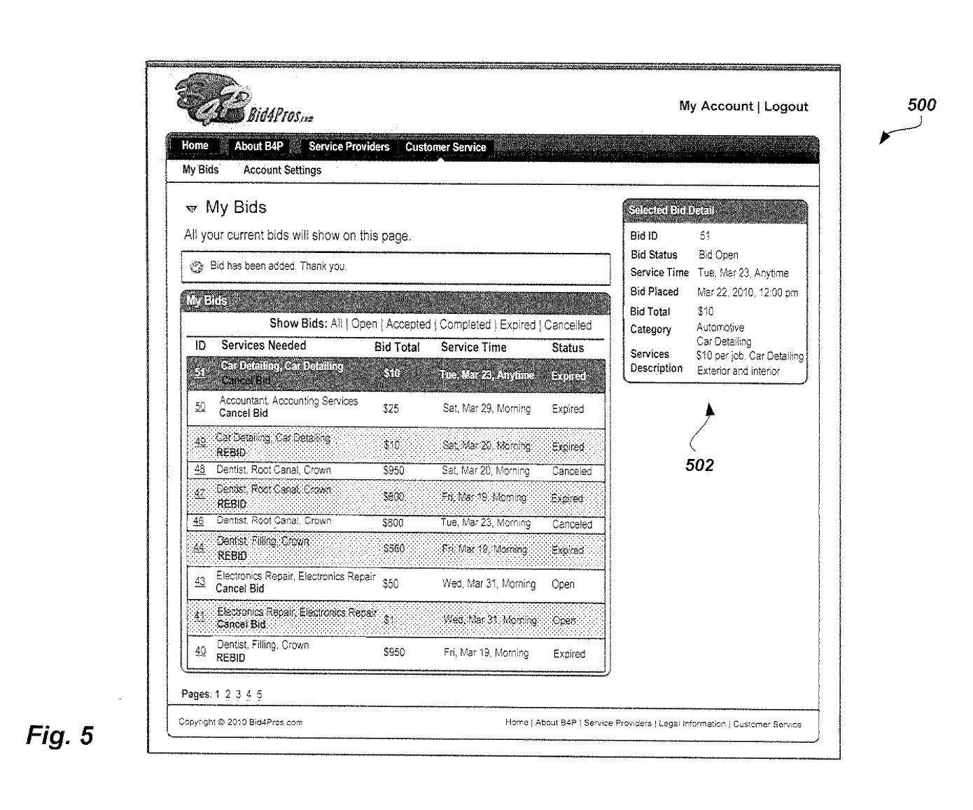

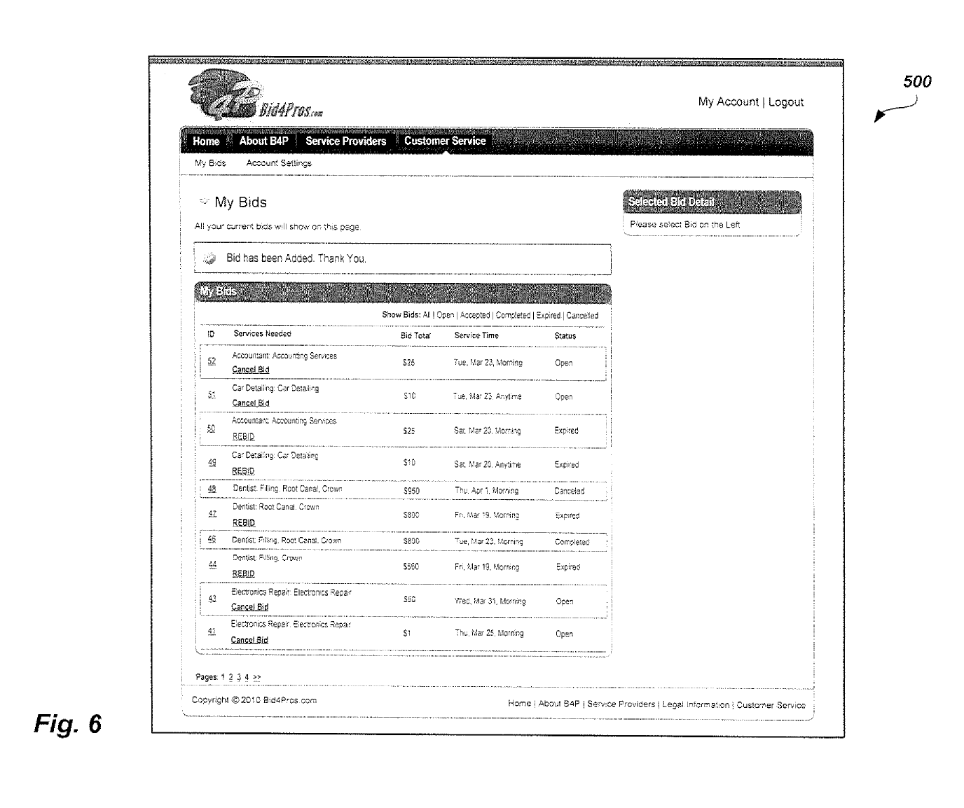

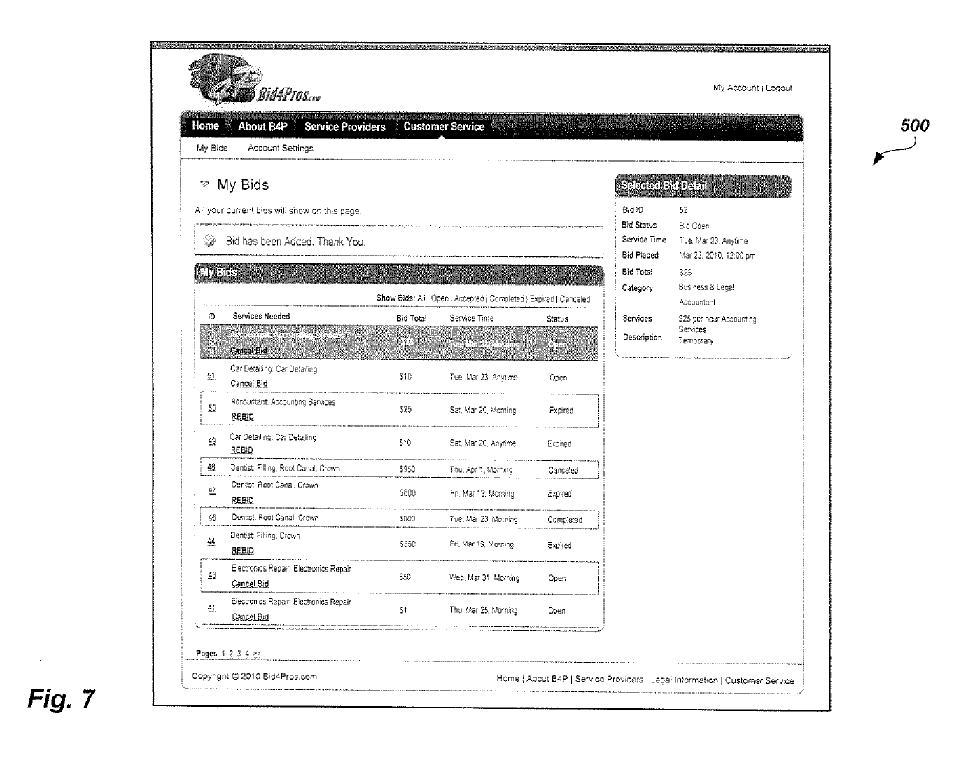

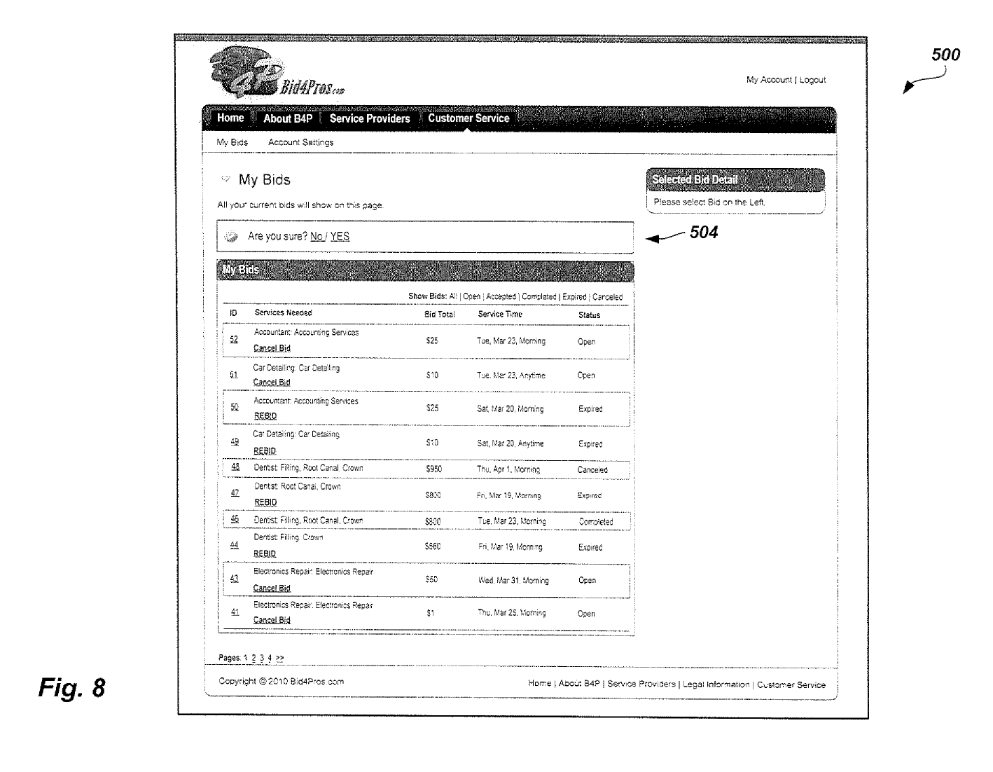

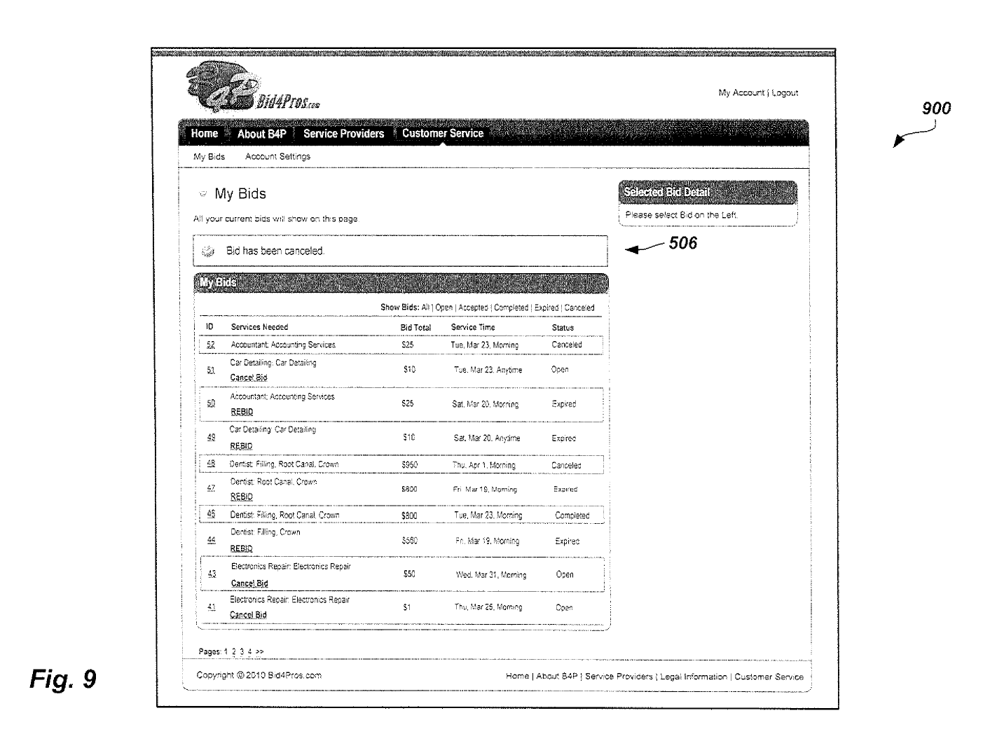

As shown in FIG. 4, Place Bid page 400 is provided in which the client can start a bid process to purchase a professional service. The client selects the specific service required and then enters his/her bid price and the date and time for the service. On the Place Bid page 400 a Place Bid button is provided to finalize client's bid per job or bid per hour and make it available to the appropriate service providers. A detailed description text entry field is provided for user entry of specific details related to the job. As shown in FIG. 5, the My Bids page 500 allows a user to view bids placed by the user and view detailed information 502 for each bid. From the My Bids page 500 the user can modify bids by canceling bids or rebidding. For example, in FIG. 5, bid 40 is expired but has a REBID link. The user can click on the REBID link and rebid on the service. Moreover, a user can add a service bid, (bid 52, as shown in FIG. 6). The cancel bid procedure is illustrated in FIGS. 7 through 9, detailing the cancellation of bid 52. A cancellation confirmation prompt 504 is displayed, as shown in FIG. 8. Once the user has confirmed the cancellation, a Bid has been cancelled message 506 is displayed, as shown in FIG. 9.

After a bid is placed, the website sends a confirmation email addressed to the bid submittal client's email inbox. The website 200 requires a reply confirmation from the client before bid placement is completed.

At the server 105, the bid confirmation triggers a backend engine to search a pre-existing database 90 of subscribed providers and to generate a list of eligible providers based on the geographic area as determined by zip code indicated by the consumer. The system sends an e-mail of the consumer's bid to each provider on the generated eligibility list. Consumer bid requests forwarded to the service providers have no indication of the consumer's identity. Thus, the bidding process is completely anonymous, thereby assuring that no contact could be established between the parties to circumvent the website's standard communication channel(s).

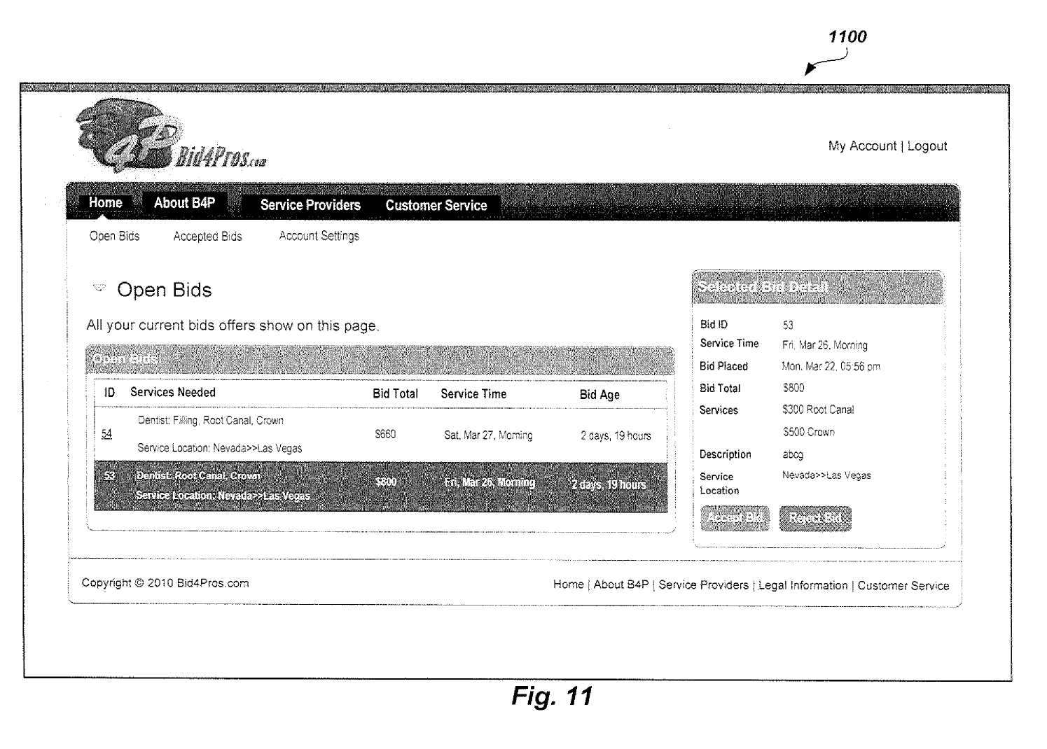

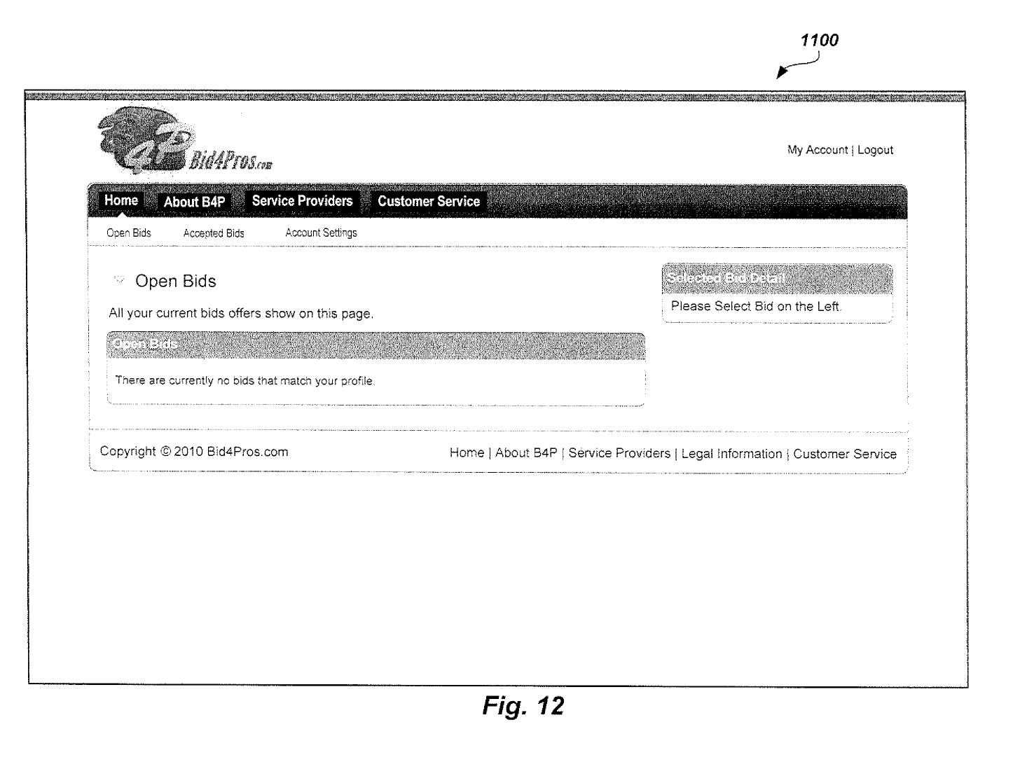

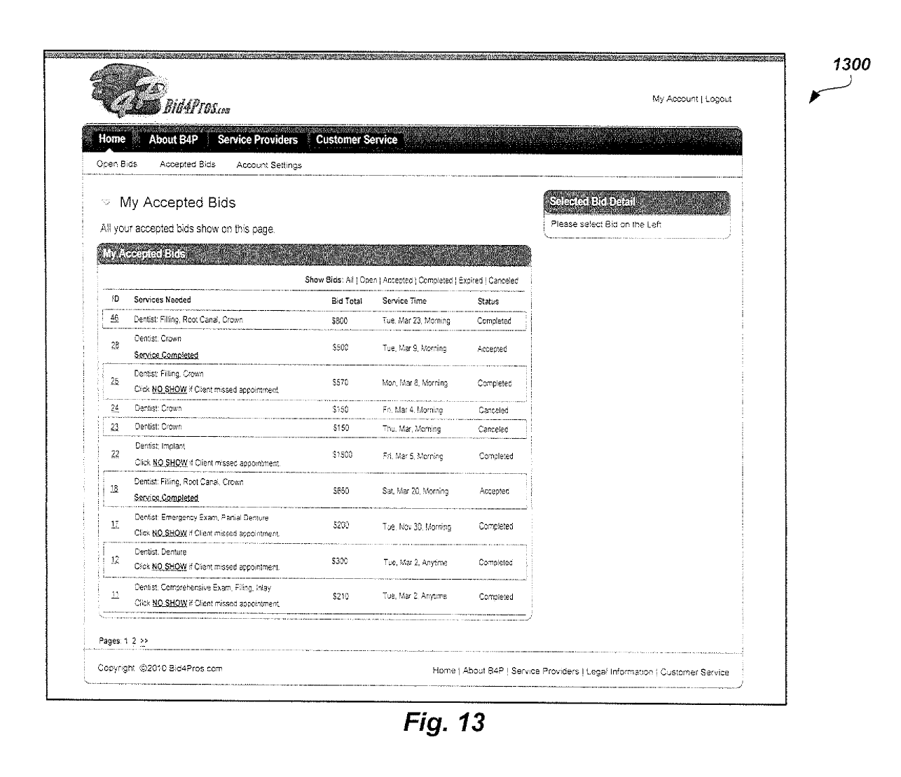

The system accepts replies to the client's bid from each of the contacted service providers who choose to respond. Each service provider response to a bid is anonymously sent back to the website and later sent to the client. The website permits an accept response or a reject response. No counter-offers are permitted. The system prompts the consumer to respond to an acceptable reply from interested service providers in a timely manner. If no service provider replies to a client bid request, the application of server 105 offers a re-bid feature in which the client can re-bid by increasing his/her previous bid dollar amount with incremental increase suggested. As shown in FIG. 11, a service provider can check his/her open bids on an Open Bids page 1100. After all bids have been either canceled or accepted, the Open bids page 1100 shows no entries, as shown in FIG. 12. As shown in FIG. 13, the service provider can use the My Accepted Bids page 1300 to check all accepted bids and status associated with his/her service for the client.

Once a client bid is approved by the provider and a reply is sent to the client via the website, the system prompts the client to call the service provider within 48-72 hours to make an appointment or else the bid price will no longer be available. The system flags any client who cancels 2 (two) consecutive appointments without notice. Additionally, the system lacks such a user out of the system for a period of six months. The system automatically keeps track of clients and periodically reminds the clients to keep their information updated.

Both service provider and client will be prompted to rate the service quality. The website has billing options, which include a monthly/Quarterly/Annual flat fee membership payable by service providers, a monthly/Quarterly/Annual flat fee membership payable by client users, a percentage of the bid price once the appointment is confirmed, the bid percentage being paid by user and/or provider, or a flat-fee on the services once the appointment is confirmed, the flat-fee being payable by the user and/or provider.

It is to be understood that the present invention is not limited to the embodiment described above, but encompasses any and all embodiments within the scope of the following claims.

I claim:

1. A professional services website, comprising:
a mass storage unit;
a web server connected to the mass storage unit, the web server publishing a plurality of web pages allowing for customer user submission of a bid/offer to pay for professional services;
an application server in operable communication with the web server and connected to the mass storage unit, the application server maintaining a database of professional service providers, the database residing on the mass storage unit; and
means for mediating communication between the customer user and professional service providers who accept the customer user's bid/offer with no preconditions.

2. The professional services website according to claim 1, further comprising means for collecting a membership fee payable by the service providers.

3. The professional services website according to claim 1, further comprising means for collecting a membership fee payable by the customer users.

4. The professional services website according to claim 1, further comprising means for the customer user's identity anonymous before presenting the customer user's bid/offer to the professional service providers.

5. The professional services website according to claim 1, further comprising means for accepting a listing for display on the website, the listing including a specific price for a specified time and date, a detailed description of a service, and an hourly or job rate of the service provided by the professional service provider.

6. The professional services website according to claim 1, further comprising:
means for transmitting the bid/offer from the customer user to the professional service providers; and
means for allowing the service providers to accept/reject the bid/offer.

7. The professional services website according to claim 1, further comprising means for registering the customer users for access to the professional services website.

8. The professional services website according to claim 1, further comprising means for registering the professional service providers for access to the professional services website.

9. The professional services website according to claim 1, further comprising:
means for accepting cancellation of the bid/offer from the customer user;
means for accepting a rebid from the customer user; and
means for withdrawing the bid/offer presented by the customer user upon occurrence of an expiration date.

10. The professional services website according to claim 1, further comprising:
means for confirming the customer user's bid/offer submittal to the customer user in confidence; and
means for requiring a reply confirmation from the customer user before placement of the bid/offer is completed.

11. The professional services website according to claim 10, further comprising means for searching said database to generate a list of eligible service providers based on a geographic area of the customer user.

12. The professional services website according to claim 10, further comprising means for allowing a customer user to track all of his/her bid/offers on the professional services website.

13. The professional services website according to claim 10, further comprising means for allowing the professional service providers and the customer users to rate quality of service of the website.

14. A computer-implemented professional services website method, comprising the steps of:
on a professional services website, posting services available from professional service providers, the services posting being viewable by customer users of the website;
presenting offers formulated by the customer users to the professional service providers of the website service;
mediating communication between the customer users and professional service providers who accept the customer users' offers with no preconditions; and
collecting a membership fee payable by the service providers.

15. The computer-implemented professional services website method according to claim 14, further comprising the step of collecting a membership fee payable by the service providers.

16. The computer-implemented professional services website method according to claim 14, further comprising the step of collecting a membership fee payable by the customer users.

17. The computer-implemented professional services website method according to claim 14, further comprising the step of making the customer user's identity anonymous before presenting the customer user's bid/offer to the professional service providers.

18. The computer-implemented professional services website method according to claim 14, further comprising the step of accepting a listing for display on the website, the listing including a specific price for a specified time and date, a detailed description of a service, and an hourly or job rate of the service provided by the professional service provider.

19. The computer-implemented professional services website method according to claim 14, further comprising the steps of:
transmitting the bid/offer from the customer user to the professional service providers; and
allowing the service providers to accept/reject the bid/offer.

20. The computer implemented professional services website method according to claim 14, further comprising the steps of:
registering the customer users for access to the professional services website;
registering the professional service providers for access to the professional services website;
accepting cancellation of the bid/offer from the customer user;
accepting a rebid from the customer user;
withdrawing the bid/offer presented by the customer user upon occurrence of an expiration date;
confirming the customer user's bid/offer submittal to the customer user in confidence;
requiring a reply confirmation from the customer user before placement of the bid/offer is completed;
searching the database to generate a list of eligible service providers based on a geographic area of the customer user;
allowing a customer user to track all of his/her bid/offers on the professional services website; and
allowing the professional service providers and the customer users to rate quality of service of the website.
